(19) United States
(12) Patent Application Publication
(10) Pub. No.: US 2026/0347109 A1
(43) Pub. Date: Nov. 5, 2026

(54) PICKING SYSTEM

(71) Applicant: MITSUBISHI HEAVY INDUSTRIES, LTD., Tokyo (JP)

(72) Inventors: Noriyuki HASEGAWA, Tokyo (JP); Tetsuhei KOBAYASHI, Tokyo (JP); Kensuke FUTAHASHI, Tokyo (JP)

(73) Assignee: MITSUBISHI HEAVY INDUSTRIES, LTD., Tokyo (JP)

(21) Appl. No.: 19/099,288

(22) PCT Filed: Feb. 17, 2023
(86) PCT No.: PCT/JP2023/005863

§ 371 Date: Jan. 28, 2025

(30) Foreign Application Priority Data
Aug. 29, 2022 (JP) 2022-135689

(51) Int. Cl. B65G 1/137

(52) U.S. Cl. CPC B65G 1/1371; B65G 2203/0216

(57) ABSTRACT

A picking system includes a diversion candidate addition unit configured to add the finished pallet to a diversion candidate in a case where it is determined that the number of predetermined type articles in a finished pallet is equal to or greater than a predetermined ratio of the number of predetermined type articles in a full single SKU pallet, an order assignment unit configured to assign an order of the finished pallet of the diversion candidate to immediately after another finished pallet configured by picking the predetermined number of articles from the replenishment pallet having the predetermined type articles according to the picking order in a case where it is determined that the finished pallet, in which the number of remaining predetermined type articles in the replenishment pallet obtained after picking a predetermined number of articles according to a picking order matches the number of predetermined type articles in the finished pallet, is present in the diversion candidate of the finished pallet.

### TECHNICAL FIELD

The present disclosure relates to a picking system.

Priority is claimed on Japanese Patent Application No. 2022-135689, filed Aug. 29, 2022, the content of which is incorporated herein by reference.

### BACKGROUND ART

In the related art, there is a picking system for stacking a predetermined number of one or more types of articles from one or more types of replenishment pallets, in which the same type of articles are stacked and stored on a pallet, on another pallet (pallet for shipment) according to a shipment order, and shipping the articles as a shipment pallet.

Non-Patent Document 1 discloses a picking system including a palletizer (picking robot) that picks an article from a required type of replenishment pallet according to a shipment order and stacks the article on a pallet for shipment, and an unmanned transport device (unmanned transport vehicle; Automated Guided Vehicle (AGV) that carries the replenishment pallet to the palletizer.

### CITATION LIST

### Non-Patent Document

Non-Patent Document 1: “Bargain Product Stacking P: [online], Mujin, Inc. [Searched on Aug. 8, 2022], Internet <URL: https://www.mujin.co.jp/solution/distribution/tokubai/

### SUMMARY OF INVENTION

### Technical Problem

In this type of picking system, it is required to efficiently perform a process of stacking a predetermined number of plurality of types of articles on a pallet even in a case where the number of robots, such as palletizers and unmanned transport devices, is small.

The present disclosure has been made in order to solve the above-described problems, and an object of the present disclosure is to provide a picking system capable of efficiently performing a process of stacking a predetermined number of plurality of types of articles on the pallet with a smaller number of robots.

### Solution to Problem

In order to solve the above-described problem, a picking system according to the present disclosure includes a finished pallet setting unit configured to set a finished pallet, on which a plurality of types of articles are stacked, based on an input picking order: an article number comparison and determination unit configured to determine whether or not the number of predetermined type articles in the finished pallet is equal to or greater than a predetermined ratio of the number of the predetermined type articles in a full single SKU pallet on which only the predetermined type articles are stacked; a di version candidate addition unit configured to add the finished pallet to a diversion candidate in a case where in a case where it is determined that the number of the predetermined type articles in the finished pallet is equal to or greater than the predetermined ratio of the number of the predetermined type articles in the full single SKU pallet; a replenishment pallet remaining number confirmation unit configured to check the number of remaining articles in a replenishment pallet after picking a predetermined number of articles according to the picking order; a diversion candidate presence/absence determination unit configured to determine whether or not the finished pallet having the number of the predetermined type articles matching the number of remaining predetermined type articles in the replenishment pallet is present in the finished pallet of the diversion candidate; and an order assignment unit configured to assign an order of the finished pallet of the diversion candidate to immediately after another finished pallet configured by picking the predetermined number of articles from the replenishment pallet having the predetermined type articles according to the picking order in a case where it is determined that the finished pallet, in which the number of the remaining predetermined type articles in the replenishment pallet matches the number of the predetermined type articles in the finished pallet, is present in the diversion candidate of the finished pallet.

### Advantageous Effects of Invention

According to the present disclosure, in the picking system, it is possible to efficiently perform a process of stacking a predetermined number of plurality of types of articles on the pallet by a smaller number of robots.

### BRIEF DESCRIPTION OF DRAWINGS

FIG. 1 A diagram showing a disposition example of a picking system according to an embodiment of the present disclosure.

FIG. 2 A block diagram showing a configuration example of a control device provided in the picking system according to the embodiment of the present disclosure.

FIG. 3 A diagram showing an example of a picking order according to the embodiment of the present disclosure.

FIG. 4 A flowchart showing a process of updating a finished pallet order in the picking system according to the embodiment of the present disclosure.

FIG. 5 A diagram showing an example of a picking order in units of the finished pallet obtained in an intermediate stage of the process shown in FIG. 4.

FIG. 6 A flowchart showing a process of up of a stacking order of articles in units of the finished pallet in the picking system according to the embodiment of the present disclosure.

FIG. 7 A flowchart showing a process of selecting a transport destination of a replenishment pallet and a process of assigning a task to an unmanned transport device in the picking system according to the embodiment of the present disclosure.

### DESCRIPTION OF EMBODIMENTS

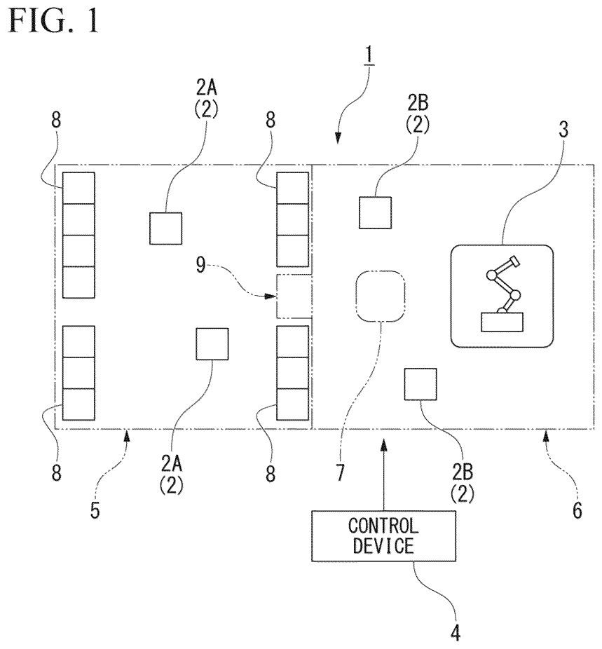

Hereinafter, a picking system according to an embodiment of the present disclosure will be described with reference to FIGS. 1 to 7.

### Configuration of Picking System

As shown in FIG. 1, a picking system 1 according to the present embodiment is a system for stacking a predetermined number of one or more types of articles from a plurality of replenishment pallets, in which the same type of a are stacked and stored on a pallet according to an input picking order (described below) in a warehouse or the like, on another pallet (pallet for shipment), and shipping the articles as a shipment pallet.

The picking system 1 of the present embodiment includes an unmanned transport device 2 configured to transport the replenishment pallet or the shipment pallet, a palletizer 3 that picks an article from the replenishment pallet and stacks the article on the pallet for shipment, and a control device 4 that controls the operations of the unmanned transport device 2 and the palletizer 3.

The unmanned transport device 2 basically transports the replenishment pallet between a storage area 5 and the palletizer 3 disposed in a stacking area 6. In addition, the unmanned transport device 2 transports the shipment pallet finished by stacking the articles by the palletizer 3 from the palletizer 3 to a shipment location (not shown). The unmanned transport device 2 may transport, for example, a pallet (empty pallet) on which an article is not placed.

The unmanned transport device 2 of the present embodiment includes an unmanned forklift 2A (AGF) that operates in the storage area 5 and an unmanned transport vehicle 2B (AGV) that operates in the stacking area 6. Each of the number of unmanned forklifts 2A in the storage area 5 and the number of unmanned transport vehicles 28 in the stacking area 6 may be one or more.

The unmanned transport vehicle 2B is configured to lift and carry the replenishment pallet, the shipment pallet, and the empty pallet from below. Therefore, a transport stand with legs is used for transporting the replenishment pallet or the like by the unmanned transport vehicle 28. The transport stand with legs is configured to be able to place the replenishment pallet or the like and to allow the unmanned transport vehicle 2B to enter a lower side of the transport stand. In consideration of picking and stacking of the articles in the palletizer, the unmanned transport vehicle 2B cannot transport the replenishment pallet or the like stacked in a vertical direction.

The stacking area 6 is an area in which the palletizer 3 mainly picks the articles from the replenishment pallet and stacks the articles on the pallet for shipment. A temporary placement area 7 is disposed in the stacking area 6. The temporary placement area 7 is a location where the replenishment pallet or the like placed on the transport stand with legs is temporarily placed.

The storage area 5 is an area for storing the replenishment pallet or the like. The storage area 5 is located farther from the palletizer 3 than the temporary placement area 7. In the present embodiment, a shelf 8 (storage shelf 8) for storing the replenishment pallet or the like is disposed in the storage area 5. The storage shelf 8 may be configured by arranging a plurality of shelf boards in, for example, a vertical direction. In this case, a plurality of the replenishment pallets and the like can be arranged in the vertical direction by the ummanned forklift 2A.

A delivery location 9 for delivering the replenishment pallet or the like between the unmanned forklift 2A and the unmanned transport vehicle 2B is provided at a boundary between the storage area 5 and the stacking area 6. As described above, since the unmanned transport vehicle 2B can transport only one replenishment pallet or the like, the replenishment pallet or the like is delivered one by one between the unmanned forklift 2A and the unmanned transport vehicle 2B at the delivery location 9.

### Configuration of Control Device

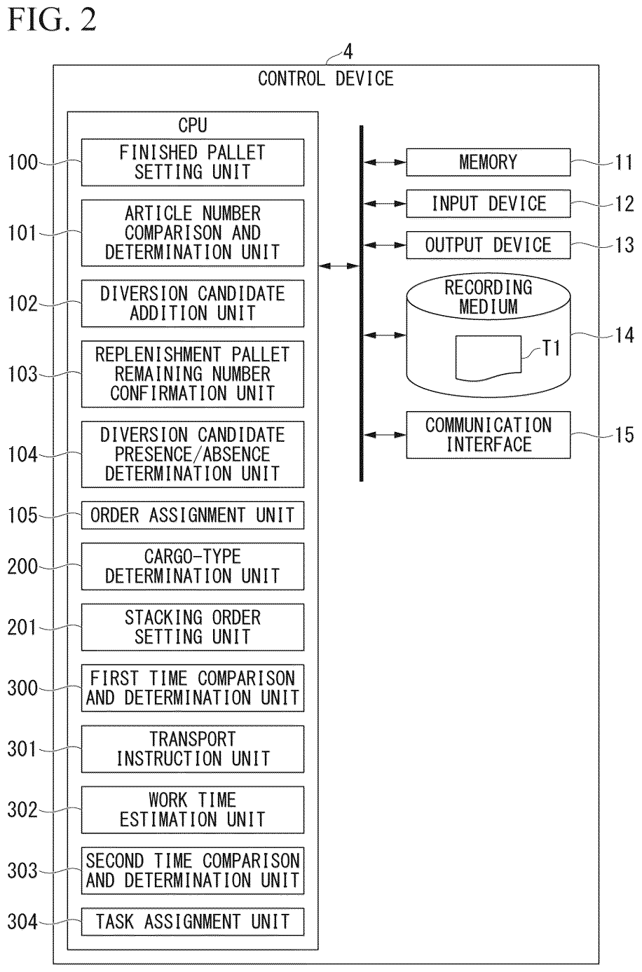

In the present embodiment, the control device 4 has a configuration of a general computer. That is, as shown in FIG. 2, the control device 4 includes a CPU 10, a memory 11, an input device 12, an output device 13, a recording medium 14, and a communication interface 15.

The CPU 10 is a processor that controls the operation of the picking system 1 as a computer.

The memory 11 is a storage region necessary for the operation of the CPU 10.

The input device 12 is, for example, a mouse, a keyboard, a touch panel, or the like.

The output device 13 is, for example, a display or the like.

The recording medium 14 is a large-capacity storage device such as an HDD or an SSD. In the present embodiment, the picking order T1 (described below) can be recorded on the recording medium 14.

The communication interface 15 transmits and receives various types of data to and from an external device. In the present embodiment, the communication interface 15 receives the picking order T1 from a warehouse management system (not shown) that manages the entire picking system 1.

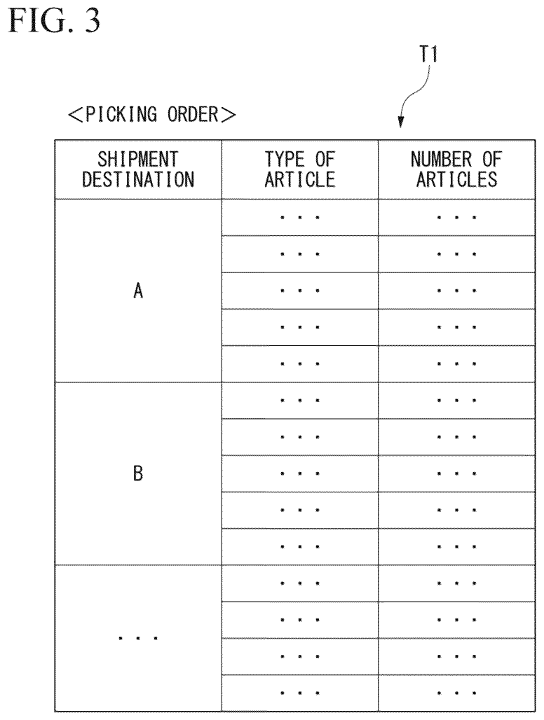

As shown in FIG. 3, the picking order T1 is a list showing a type of an article required by each shipment destination (customer) and the number of articles for each type. In the picking order T1 of FIG. 3, the type of the article and the number of articles for each type are shown for each shipment destination.

As shown in FIG. 2, the CPU 10 has functions as a finished pallet setting unit 100, an article number comparison and determination unit 101, a diversion candidate addition unit 102, a replenishment pallet remaining number confirmation unit 103, a diversion candidate presence/absence determination unit 104, an order assignment unit 105, a cargo-type determination unit 200, a stacking order setting unit 201, a first time comparison and determination unit 300, a transport instruction unit 301, a work time estimation unit 302, a second time comparison and determination unit 303, and a task assignment unit 304 by operating in accordance with a specific program.

The finished pallet setting unit 100 sets a finished pallet on which a plurality of types of articles are stacked based on the picking order T1 input to the control device 4. The finished pallet is a virtual shipment pallet on which stacking of a plurality of types of articles is optimized based on the picking order T4. The finished pallet setting unit 100 sets one or more finished pallets for each shipment destination.

The article number comparison and determination unit 101 determines whether or not the number of predetermined type articles in the finished pallet is equal to or greater than a predetermined ratio of the number of predetermined type articles in a full single SKU (Stock Keeping Unit) pallet in which only the predetermined type articles are stacked. The “full single SKU pallet” is a replenishment pallet in a state in which the same type articles are stacked 100%. The predetermined ratio of the number of predetermined type articles in the full single SKU pallet is a value that is at least greater than 0 and less than 1. The “predetermined ratio” may be, for example, ½, ⅓, ¼, or the like.

The diversion candidate addition unit 102 adds the finished pallet to the diversion candidate in a case where it is determined that the number of predetermined type articles in the finished pallet is equal to or greater than the predetermined ratio of the number of predetermined type articles in the full single SKU pallet. The finished pallet that is the diversion candidate is a finished pallet in which the number of predetermined type articles is equal to or greater than the predetermined ratio of the number of predetermined type articles in the full single SKU pallet.

The replenishment pallet remaining number confirmation unit 103 checks the number of remaining articles in the replenishment pallet after picking a predetermined number of articles according to the picking order T1. The “number of remaining articles” checked by the replenishment pallet remaining number confirmation unit 103 is a number obtained by subtracting the number of articles, which are picked by the palletizer 3 from the replenishment pallet according to the picking order T1, from the number of articles in the replenishment pallet before picking. The number of articles in the replenishment pallet before picking may be the number of articles in the full single SKU pallet or may be the number of articles in the replenishment pallet whose number of articles stacked is smaller than the number of articles in the full single SKU pallet.

The diversion candidate presence/absence determination unit 104 determines whether or not a finished pallet having the number of predetermined type articles, which matches the number of remaining predetermined type articles in the replenishment pallet, is present in the finished pallet of the diversion candidate.

In a case where it is determined that the finished pallet, in which the number of remaining predetermined type articles in the replenishment pallet matches the number of predetermined type articles in the finished pallet, is present in the diversion candidate of the finished pallet, the order assignment unit 105 assigns the order of the finished pallet of the diversion candidate to be immediately after another finished pallet configured by picking the predetermined number of articles from the replenishment pallet having the predetermined type articles according to the picking order T1. That is, the order assignment unit 105 changes the order of the finished pallets to be processed such that the remaining replenishment pallet, obtained after picking the predetermined number of articles from the replenishment pallet having the predetermined type articles and stacking. the articles on another finished pallet by the palletizer 3, is diversion to a next finished pallet.

The cargo-type termination unit 200 determines whether or not the type of the last article to be stacked at the end of the finished pallet immediately before a predetermined finished pallet is included in the type of the article to be stacked on the predetermined finished pallet.

In a case where it is determined that the type of the last article to be stacked at the end of the immediately before finished pallet is included in the type of the article to be stacked on the predetermined finished pallet, the stacking order setting unit 201 sets the type of the last article to the type of the article to be stacked at the beginning of the predetermined finished pallet. That is, the stacking order setting unit 201 changes the order of the types of articles to be stacked on the predetermined finished pallet.

In addition, the cargo-type determination unit 200 determines whether or not the type of the first article to be stacked at the beginning of the finished pallet immediately after the predetermined finished pallet is included in the type of the article to be stacked on the predetermined finished pallet.

In addition, in a case where it is determined that the type of the first article to be stacked at the beginning of the immediately after the finished pallet is included in the type of the article to be stacked on the predetermined finished pallet, the stacking order setting unit 201 sets the type of the first article to the type of the article to be stacked last on the predetermined finished pallet.

The first time comparison and determination unit 300 determines whether or not an estimated time until the same replenishment pallet is used again in the palletizer 3 is equal to or shorter than a predetermined first determination threshold value. In the present embodiment, the first determination threshold value is defined as a value corresponding to a round trip time for the unmanned transport device 2 returning the replenishment pallet from the palletizer 3 to the storage area 5 and then transporting the replenishment pallet from the storage area 5 to the palletizer 3. The first determination threshold value may be, for example, an actually measured round trip time, an average value of the measured round trip time, or a time appropriately set by the administrator of the picking system 1.

The transport instruction unit 301 transports the replenishment pallet from the palletizer 3 to the temporary placement area 7 by the unmanned transport device 2 in a case where it is determined that the estimated time is equal to or shorter than the first determination threshold value, and transports the replenishment pallet from the palletizer 3 to the storage area 5 by the unmanned transport device 2 in a case where it is determined that the estimated time is greater than the first determination threshold value. In the present embodiment, the transport of the replenishment pallet from the palletizer 3 to the temporary placement area 7 is performed only by the unmanned transport vehicle 2B in the unmanned transport device 2. In addition, the transport of the replenishment pallet from the palletizer 3 to the storage area 5 is performed by the unmanned transport vehicle 28 and the unmanned forklift 2A in the unmanned transport device 2

The work time estimation unit 302 estimates the work time for the palletizer 3 to pick the article from the same replenishment pallet.

The second time comparison and determination unit 303 determines whether or not the estimated work time for the palletizer 3 to pick the article from the predetermined replenishment pallet is equal to or longer than a predetermined second determination threshold value. The estimated work time is a “work time” estimated by the work time estimation unit 302. The second determination threshold value is a time set by the administrator of the picking system 1, and may be, for example, a time during which the unmanned transport device 2 can sufficiently perform job (task) other than the transport of the replenishment pallet. For example, in a case where the time for the unmanned transport vehicle 2B to perform one job (task) is 50 seconds, the time for the unmanned transport vehicle 2B to sufficiently perform another job may be set to, for example, a time for performing 10 jobs, that is, 500 seconds.

The task assignment unit 304 assigns the unmanned transport device 2 a task of transporting the next replenishment pallet to the temporary placement area 7 without transporting the next replenishment pallet to the palletizer 3 in a case where it is determined that the estimated work time is equal to or longer than the second determination threshold value, and assigns the unmanned transport device 2 a task of transporting the next replenishment pallet to the palletizer 3 in a case where it is determined that the estimated work time is less than the second determination threshold value. The “next replenishment pallet” transported by the unmanned transport device 2. is a replenishment pallet in which an article is picked by the palletizer 3 after a “current replenishment pallet” in which an article is picked by the palletizer 3.

### Process of Updating Order of Finished Pallet

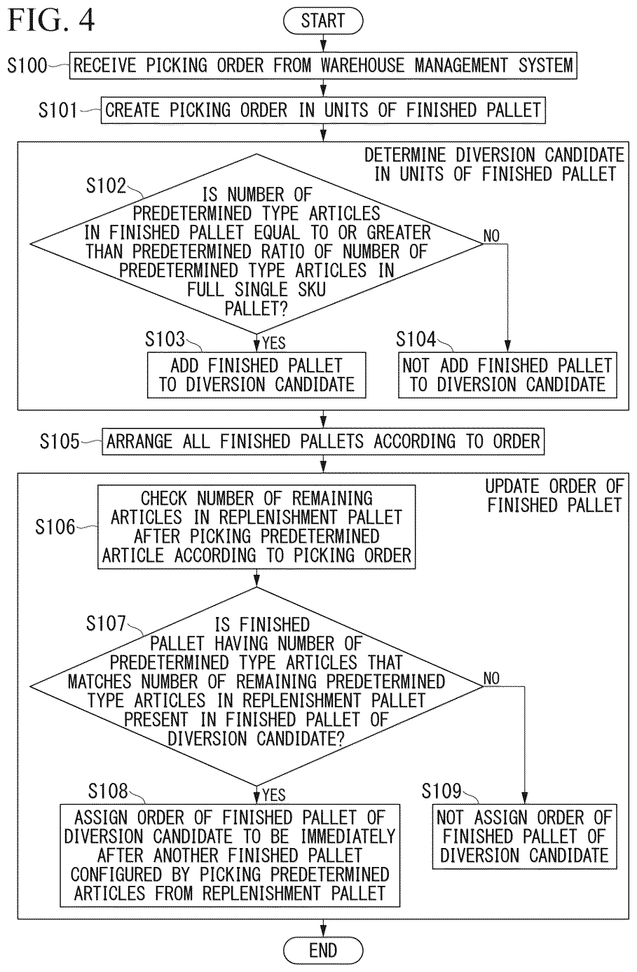

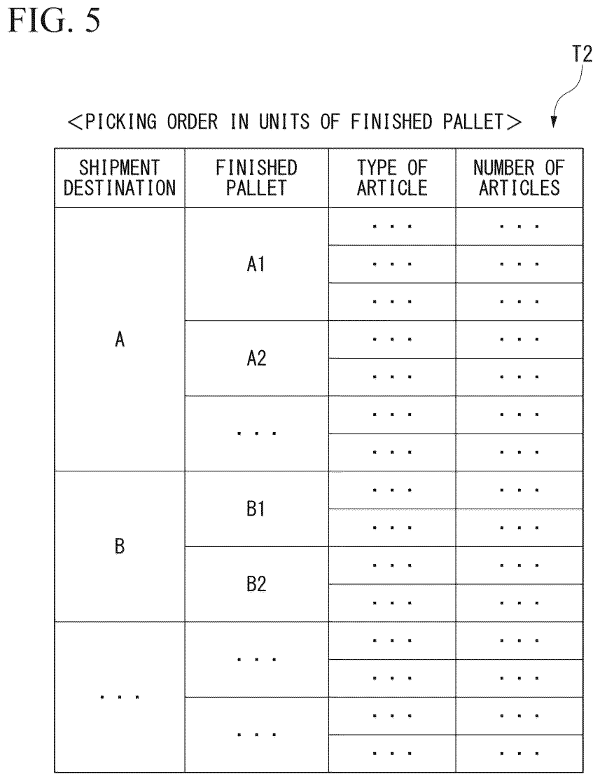

Hereinafter, the process of the CPU 10 of the control device 4, particularly, the finished pallet setting unit 100, the article number comparison and determination unit 101, the diversion candidate addition unit 102, the replenishment pallet remaining number confirmation unit 103, the diversion candidate presence/absence determination unit 104, and the order assignment unit 105 will be described with reference to FIGS. 4 and 5.

As shown in FIG. 4, the CPU 10 of the control device 4 receives the picking order T1 from the warehouse management system (step S100). The received picking order T1 is recorded on the recording medium 14.

Next, the finished pallet setting unit 100 of the control device 4 sets the finished pallet on which a plurality of types of articles are stacked based on the input picking order T1 (step S101). In the process of step S101, the finished pallet setting unit 100 creates a picking order T2 in units of the finished pallet shown in FIG. S based on the picking order T1. Specifically, the finished pallet setting unit 100 sets the plurality of types of articles to be shipped to a predetermined shipment destination (for example, the shipment destination A shown in FIGS. 3 and 5) to be appropriately distributed to the plurality of finished pallets (for example, the plurality of finished pallets A1, A2, . . . shown in FIG. 5) based on the picking order T1. It is preferable that the same type of articles to be shipped to the same shipment destination are disposed on the same finished pallet. The same type of articles to be shipped to different shipment destinations are separately disposed in separate finished pallets (for example, the finished pallet A2 and the finished pallet BI shown in FIG. 5).

Next, the article number comparison and determination unit 101 determines whether or not the number of predetermined type articles in the finished pallet is equal to or greater than a predetermined ratio of the number of predetermined type articles in the full single SKU pallet in which only the predetermined type articles are tacked (step S102).

In a case where the article number comparison and determination unit 101 determines that the number of predetermined type articles in the finished pallet is equal to or greater than the predetermined ratio of the number of predetermined type articles in the full single SKU pallet. the diversion candidate addition unit 102 adds the finished pallet to the diversion candidate (step S103). On the other hand, in a case where the article number comparison and determination unit 101 determines that the number of predetermined type articles in the finished pallet is smaller than the predetermined ratio of the number of predetermined type articles in the full single SKU pallet, the diversion candidate addition unit 102 does not add the finished pallet to the diversion candidate (step S104).

The processes of steps S102 to S104 are performed in units of the finished pallet.

After steps S102 to S104 are appropriately performed for all the finished pallets, the CPU 10 of the control device 4 arranges all the finished pallets in order (step S105). The order of the finished pallets arranged in step S105 corresponds to a provisional order in which the shipment pallets are created in the picking system 1.

After step S105, the replenishment pallet remaining number confirmation unit 103 checks the number of remaining articles in the replenishment pallet after picking the predetermined number of articles according to the picking order T1 (step S106). The number of remaining articles in the replenishment pallet after picking is checked in units of the list (type of the article in which the type of article and the number of articles correspond to each other on a one-to-one basis) in the picking order T1.

The number of remaining articles may be checked for all the lists (article varieties), but for example, for the type of the article in which the number of articles is equal to or greater than a predetermined ratio of the number of articles in the full single SKU pallet among the type of the article included in the finished pallet of the diversion candidate, the number of remaining articles in the replenishment pallet may not be checked.

Thereafter, the diversion candidate presence/absence determination unit 104 determines whether or not the finished pallet having the number of predetermined type articles that matches the number of remaining predetermined type articles in the replenishment pallet is present in the finished pallet of the diversion candidate (step S107). The number of remaining articles in the replenishment pallet taken up in step S107 may be limited to a value equal to or greater than the predetermined ratio of the number of articles in the full single SKU pallet. The fact that the finished pallet, in which the number of remaining predetermined type articles in the replenishment pallet and the number of predetermined type articles in the finished pallet match each other, is present in the diversion candidate of the finished pallet means that the number of remaining predetermined type articles in a certain replenishment pallet matches the number of predetermined type articles in a certain diversion candidate finished pallet and is equal to or greater than a predetermined ratio of the number of predetermined type articles in the full single SKU pallet.

In a case where the diversion candidate presence/absene determination unit 104 determines that the finished pallet, in which the number of remaining predetermined type articles in the replenishment pallet and the number of predetermined type articles in the finished pallet match each other, is present in the diversion candidate of the finished pallet, the order assignment unit 105 assigns the order of the finished pallet of the diversion candidate to be immediately after another finished pallet configured by picking the predetermined number of articles from the replenishment pallet having the predetermined type articles according to the picking order T1 (step S108), On the other hand, in a case where the diversion candidate presence/absence determination unit 104 determines that the finished pallet, in which the number of remaining predetermined type articles in the replenishment pallet and the number of predetermined type articles in the finished pallet match, is not present in the diversion candidate of the finished pallet, the order assignment unit 105 does not perform the assignment of the order of the finished pallet of the diversion candidate (step S109). The processes of steps S107 to S109 are performed in units of the finished pallet of the diversion candidate.

### Process of Updating Stacking Order of Article in Finished Pallet Unit

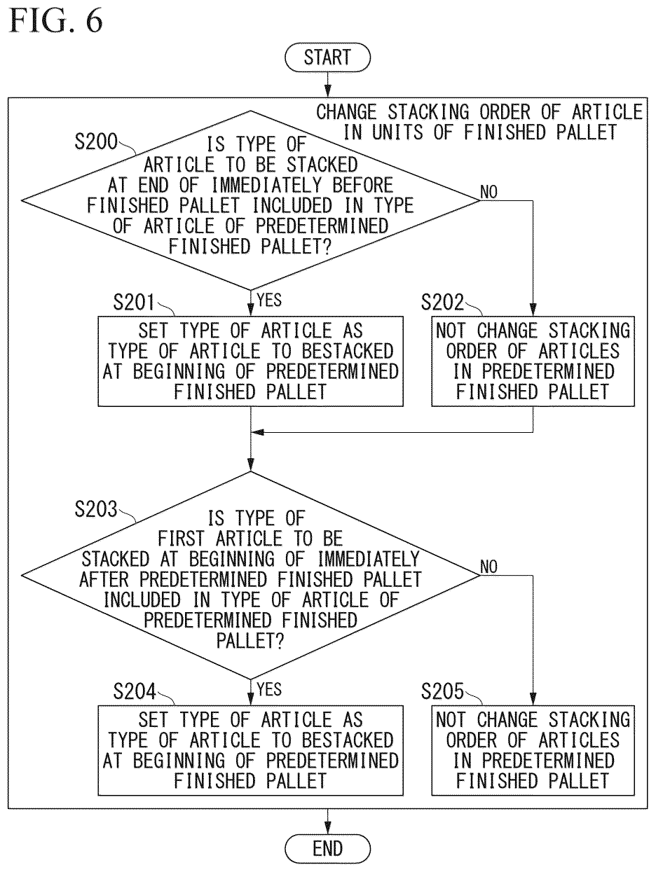

Next, the process of the cargo type determination unit 200 and the stacking order setting unit 201 of the control device 4 will be described with reference to FIG. 6. The process described below will be described as being performed after all the processes. shown in FIG. 4.

As shown in FIG. 6, the cargo-type determination unit 200 determines whether or not the type of the last article to be stacked at the end of the finished pallet immediately before the predetermined finished pallet is included in the type of the article to be stacked on the predetermined finished pallet (step S200).

In a case where go-type determination unit 200 determines that the type of the last article to be stacked at the end of the immediately before finished pallet is included in the type of the article to be stacked on the predetermined finished pallet, the stacking order setting unit 201 sets the type of the last article as the type of the article to be stacked at the beginning of the predetermined finished pallet (step S201). That is, the stacking order setting unit 201 updates the order of the types of articles to be stacked on the predetermined finished pallet. On the other hand, in a case where the cargo-type determination unit 200 determines that the type of the last article to be stacked at the end of the immediately before finished pallet is not included in the type of the article to be stacked on the predetermined finished pallet, the stacking order setting unit 201 does not update the order of the article types to be stacked on the predetermined finished pallet (step S202).

After step S201 or S202, the cargo-type determination unit 200 determines whether or not
the type of the first article to be stacked at the beginning of the finished pallet immediately after the predetermined finished pallet is included in the type of the article to be stacked on the predetermined finished pallet (step S203).

In a case where the cargo-type determination unit 200 determines that the type of the first article to be stacked a beginning of the finished pallet immediately after the predetermined finished pallet is included in the type of the article to be stacked on the predetermined finished pallet, the stacking order setting unit 201 sets the type of the first article as the type of the article to be stacked last in the predetermined finished pallet (step S204). That is, the stacking order setting unit 201 updates the order of the types of articles to be stacked on the predetermined finished pallet. On the other hand, in a case where the cargo-type determination unit 200 determines that the type of the fist article of to be stacked at the beginning of the finished pallet immediately after the predetermined finished pallet is not included in the type of the article to be stacked on the predetermined finished pallet, the stacking order setting unit 201 does not update the order of the article types to be stacked on the predetermined finished pallet (step S205).

Steps S200 to S205 described above are performed in units of the finished pallet.

In the process shown in FIG. 6, the processes of steps S203 to S205 may be performed, for example, before the processes of step S200 to S202.

In addition, the process shown in FIG. 6 is not limited to being performed after all the processes shown in FIG. 4, and may be continuously performed, for example, after the process of step S101 in FIG. 4.

### Process of Selecting Transport Destination of Replenishment Pallet

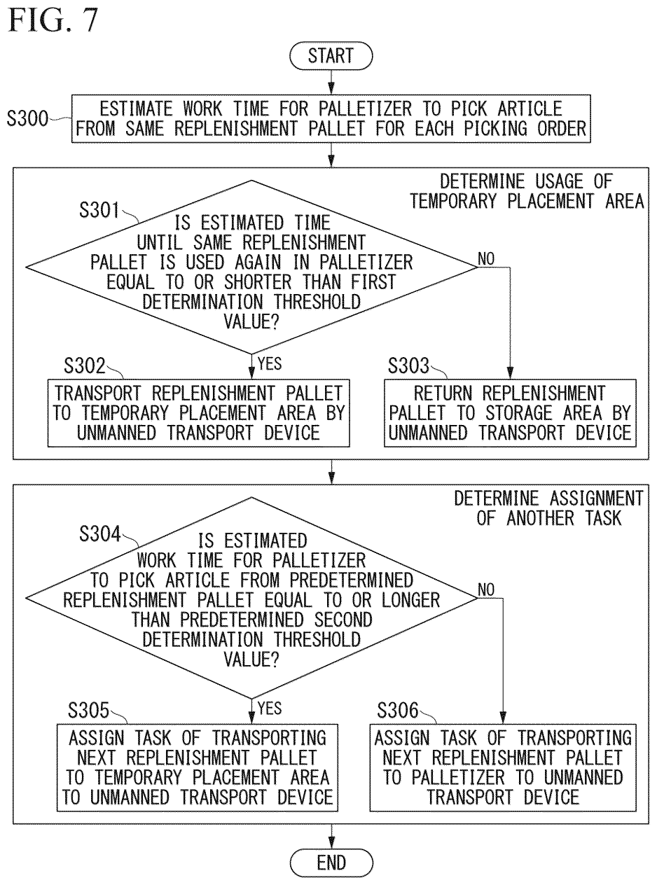

Next, a process of the first-time comparison and determination unit 300 and the transport instruction unit 301 of the control device 4 will be described with reference to FIG. 7. The process described below will be described as being performed after all the processes shown in FIG. 6.

As shown in FIG. 7, the first-time comparison and determination unit 300 determines whether or not the estimated time until the same replenishment pallet is used again in the palletizer 3 is equal to or shorter than the predetermined first determination threshold value (step S301). The first-time comparison and determination unit 300 determines the estimated time in units of a list (the type of the article in which the type of article and the number of articles correspond to each other on a one-to-one basis) in the picking order T1.

In a case where the first-time comparison and determination unit 300 determines that the estimated time is equal to or shorter than the first determination threshold value, the transport instruction unit 301 transports the replenishment pallet from the palletizer 3 to the temporary placement area 7 by the unmanned transport device 2 (step S302). On the other hand, in a case where the first-time comparison and determination unit 300 determines that the estimated time is greater than the first determination threshold value, the transport instruction unit 301 transports the replenishment pallet from the palletizer 3 to the storage area 5 by the unmanned transport device 2 (step S303). That is, in steps S301 to S303, it is determined whether or not to use the temporary placement area 7 in units of the list in the picking order T1.

### Process of Assigning Task to Unmanned Transport Device

Next, the processes of the work time estimation unit 302, the second time comparison and determination unit 303, and the task assignment unit 304 of the control device 4 will be described with reference to FIG. 7. The process described below will be described as being performed after all the processes shown in FIG. 6.

The work time estimation unit 302 estimates the work time for the palletizer 3 to pick the article from the same replenishment pallet (step S300). The work time estimation unit 302 estimates the work time for each “type of article” in the picking order T1. In FIG. 7, the process of step S300 is performed before the processes of steps S301 to S303 described above, but may be performed, for example, after the processes of steps S301 to S303.

The second time comparison and determination unit 303 determines whether or not the estimated work time for the palletizer 3 to pick the article from the predetermined replenishment pallet is equal to or longer than a predetermined second determination threshold value (step S304). The estimated work time used in step S304 is the work time estimated in the process of step S300 described above.

In a case where the second time comparison and determination unit 303 determines that the estimated work time is equal to or longer than the second determination threshold value, the task assignment unit 304 assigns a task of transporting the next replenishment pallet to the temporary placement area 7 without transporting the next replenishment pallet to the palletizer 3 to the unmanned transport device 2 (step. S305). On the other hand, in a case where the second time comparison and determination unit 303 determines that the estimated work time is less than the second determination threshold value, the task assignment unit 304 assigns the task of transporting the next replenishment pallet to the palletizer 3 to the unmanned transport device 2 (step S306). In the present embodiment, the main target to which the task assignment unit 304 assigns the predetermined task in step S305 and step S306 is the unmanned transport vehicle 2B, but the target may include, for example, the unmanned forklift 2A.

In the process of step S305, for example, the task assignment unit 304 may assign another task to the unmanned transport device 2 (particularly, the unmanned transport vehicle 2B). Other tasks include, for example, a task of transporting an empty pallet or a transport stand.

In FIG. 7, the processes of steps S304 to S306 are performed after the process of steps S301 to S303 but may be performed after at least the process of step S300. Therefore, the processes of steps S304 to S306 may be performed, for example, before the processes of steps S301 to S303.

All the processes shown in FIG. 7 are not limited to being performed after all the processes shown in FIOS, 4 and 6, and may be continuously performed, for example, after the process of step S101 in FIG. 4.

### Effects

In the picking system 1 of the present embodiment, in a case where the article number comparison and determination unit 101 determines that the number of predetermined type articles in the finished pallet is equal to or greater than a predetermined ratio of the number of predetermined ty e articles in the full single SKU pallet in which only the predetermined type articles are stacked, the diversion candidate addition unit 102 adds the finished pallet to the diversion candidate. In a case where the diversion candidate presence/absence determination unit 104 determines that the finished pallet, in which the number of remaining predetermined type articles in the replenishment pallet after picking the predetermined number of articles according to the picking order T1 and the number of predetermined type articles in the finished pallet match each other, is present in the diversion candidate of the finished pallet, the order assignment unit 105 assigns the order of the finished pallet of the diversion candidate immediately after another finished pallet in which the predetermined number of articles are picked from the replenishment pallet having the predetermined type article according to the picking order T1.

Accordingly, the remaining replenishment pallet after the palletizer 3 picks the predetermined number of articles from the replenishment pallet having the predetermined type articles and stacks the articles on another finished pallet can be diversion to the next finished pallet. Here, the number of predetermined type articles in the remaining replenishment pallet is equal to or greater than the predetermined ratio of the number of articles in the full single SKU pallet, and matches the number of predetermined type articles set in the next finished pallet.

In this way, by diverting the remaining replenishment pallet to the next finished pallet, it is possible to omit the stacking of the predetermined type of article on the next finished pallet by the palletizer 3. In addition, it is possible to reduce the number of times that the replenishment pallet is supplied (transported) to the palletizer 3 by the unmanned transport device 2. That is, it is possible to reduce the work amount of the palletizer 3 and the unmanned transport device 2. Therefore, it is possible to efficiently perform the process of stacking a predetermined number of a plurality of types of articles on the pallet by a smaller number of robots (palletizer 3 and the unmanned transport device 2).

In addition, in the picking system 1 of the present embodiment, in a case where the cargo-type determination unit 200 determines that the type of the last article to be stacked at the end of the immediately before finished pallet is included in the type of the article to be stacked on the predetermined finished pallet, the stacking order setting unit 201 sets the type of the last article to the type of the article to be stacked at the beginning of the predetermined finished pallet. Therefore, the palletizer 3 can stack the same type of articles stacked on the replenishment pallet at the end of a certain finished pallet and then stack the same type of articles at the beginning of the next finished pallet. That is, it is possible to stack the articles stacked on the same replenishment pallet on two consecutive finished pallets. Accordingly, it is possible to reduce the number of times that the same type of replenishment pallet is supplied (transported) to the palletizer 3 by the unmanned transport device 2. That is, it is possible to reduce the work amount of the unmanned transport device 2. Therefore, it is possible to efficiently perform the process of stacking a predetermined number of a plurality of types of articles on the pallet by a smaller number of unmanned transport devices 2.

In addition, in the picking system 1 of the present embodiment, the cargo-type determination unit 200 determines that the type of the first article to be stacked at the beginning of the finished pallet immediately after the predetermined finished pallet is included in the type of the article to be stacked on the predetermined finished pallet, the stacking order setting unit 201 sets the type of the first article as the type of the article to be stacked last in the predetermined finished pallet. Therefore, the palletizer 3 can stack the same type of articles stacked on the replenishment pallet at the end of the predetermined finished pallet and then stack the same type of articles at the beginning of the immediately after the finished pallet. That is, it is possible to stack the articles stacked on the same replenishment pallet on two consecutive finished pallets, Accordingly, it is possible to reduce the number of times that the same type of replenishment pallet is supplied (transported) to the palletizer 3 by the unmanned transport device 2. That is, it is possible to reduce the work amount of the unmanned transport device 2. Therefore, it is possible to efficiently perform the process of stacking a predetermined number of a plurality of types of articles on the pallet by a smaller number of unmanned transport devices 2.

In addition, in the picking system I of the present embodiment, in a case where the first time comparison and determination unit 300 determines that the estimated time until the same replenishment pallet is used again in the palletizer 3 is equal to or shorter than the first determination threshold value, the unmanned transport device 2 does not return the replenishment pallet to the storage area 5, and transports the replenishment pallet to the temporary placement area 7 closer to the palletizer 3 than the storage area 5. Accordingly, it is possible to reduce the work amount of the unmanned transport device 2. Therefore, it is possible to efficiently perform the process of stacking a predetermined number of a plurality of types of articles on the pallet by a smaller number of unmanned transport devices 2.

In addition, in the picking system 1 of the present embodiment, the first determination threshold value is defined as a value corresponding to the round-trip time for the unmanned transport device 2 returning the replenishment pallet from the palletizer 3 to the storage area 5 and then transporting the replenishment pallet from the storage area 5 to the palletizer 3. Accordingly, it is possible to efficiently reduce the work amount of the unmanned transport device 2.

In addition, in the picking system 1 of the present embodiment, in a case where the second time comparison and determination unit 303 determines that the estimated work time for the palletizer 3 to pick the article from the predetermined replenishment pallet is equal to or longer than the second determination threshold value, the unmanned transport device 2 transports the next replenishment pallet to the temporary placement area 7 without transporting the next replenishment pallet to the palletizer 3. Accordingly, the next replenishment pallet can be left on the temporary placement area 7. Therefore, the task assignment unit 304 can assign another task (for example, a task of transporting an empty pallet or a transport stand) to the unmanned transport device 2. That is, it is possible to reduce the waiting time of the unmanned transport device 2. Therefore, it is possible to efficiently perform the process of stacking a predetermined number of a plurality of types of articles on the pallet by a smaller number of unmanned transport devices 2.

Although the embodiments of the present disclosure have been described in detail with reference to the drawings, the specific configuration is not limited to these embodiments, and design change and the like within a range that do not deviate from the gist of the present disclosure are also included.

For example, in the above-described embodiment, the CPU 10 of the control device 4 includes all of the finished pallet setting unit 100, the article number comparison and determination unit 101, the diversion candidate addition unit 102, the replenishment pallet remaining number confirmation unit 103, the diversion candidate presence/absence determination unit 104, the order assignment unit 105, the cargo-type determination unit 200, the stacking order setting unit 201, the first time comparison and determination unit 300, the transport instruction unit 301, the work time estimation unit 302, the second time comparison and determination unit 303, and the task assignment unit 304, but the present disclosure is not limited thereto.

The CPU 10 may include only, for example, the finished pallet setting unit 100. the article number comparison and determination unit 101, the diversion candidate addition unit 102, the replenishment pallet remaining number confirmation unit 103, the diversion candidate presence/absence determination unit 104, and the order assignment unit 105.

In addition, the CPU 10 may include, for example, only the cargo-type determination unit 200 and the stacking order setting unit 201.

In addition, the CPU 10 may include, for example, only the first-time comparison and determination unit 300 and the transport instruction unit 301.

In addition, the CPU 10 may include, for example, only the work time estimation unit 302, the second time comparison and determination unit 303, and the task assignment unit 304.

In the present disclosure, a procedure of various types of esses executed by the control device 4 of the picking system 1 is stored in a computer-readable recording medium 14 in a form of a program, and the various types of processes are performed by reading and executing the program by the computer. The computer-readable recording media 14 include magnetic disks, magneto-optical disks, CD-ROMs, DVD-ROMs, semiconductor memories, and the like. Alternatively, this computer program may be distributed to a computer via a communication line, and the computer receiving the distribution may execute the program.

The above program may be for realizing a part of the above-described functions. Further, the program may be a so-called difference file (difference program) capable of realizing the functions described above in combination with a program recorded in advance in the computer system.

In addition, in the present disclosure, the control device 4 of the picking system 1 is provided with the CPU 10 inside, may be realized only by hardware or may be realized by a custom LSI such as a Field Programmable Gate Array (FPGA) in addition to an aspect in which the CPU 10 executes the process according to a program.

### Appendix

The picking system 1 described in the above-described embodiment is understood as follows, for example.
(1) A picking system 1 according to a first aspect includes a finished pallet setting unit 100 configured to set a finished pallet, on which a plurality of types of articles are stacked, based on an input picking order T1; an article number comparison and determination unit 101 configured to determine whether or not the number of predetermined type articles in the finished pallet is equal to or greater than a predetermined ratio of the number of the predetermined type articles in a full single SKU pallet on which only the predetermined type articles are stacked; a diversion candidate addition unit 102 configured to add the finished pallet to a diversion candidate in a case where it is determined that the number of the predetermined type articles in the finished pallet is equal to or greater than the predetermined ratio of the number of the predetermined type articles in the full single SKU pallet; a replenishment pallet remaining number confirmation unit 103 configured to check the number of remaining articles in a replenishment pallet after picking a predetermined number of articles according to the picking order T1; a diversion candidate presence/absence determination unit 104 configured to determine whether or not the finished pallet having the number of the predetermined type articles matching the number of remaining predetermined type-articles in the replenishment pallet is present in the finished pallet of the diversion candidate; and an order assignment unit 105 configured to assign an order of the finished pallet of the diversion candidate to immediately after another finished pallet configured by picking the predetermined number of articles from the replenishment pallet having the predetermined type articles according to the picking order T1 in a case where it is determined that the finished pallet, in which the number of remaining predetermined type articles in the replenishment pallet matches the number of predetermined type articles in the finished pallet, is present in the diversion candidate of the finished pallet.

In the above configuration, the remaining replenishment pallet after the palletizer 3 picks the predetermined number of articles from the replenishment pallet having the predetermined type articles and stacks the articles on another finished pallet can be diversion to the next finished pallet. Here, the number of predetermined type articles in the remaining replenishment pallet is equal to or greater than the predetermined ratio of the number of articles in the full single SKU pallet, and matches the number of predetermined type articles set in the next finished pallet.

In this way, by diverting the remaining replenishment pallet to the next finished pallet, it is possible to omit the stacking of the predetermined type of article on the next finished pallet by the palletizer 3. In addition, it is possible to reduce the number of times that the replenishment pallet is supplied (transported) to the palletizer 3 by the unmanned transport device 2. That is, it is possible to reduce the work amount of the palletizer 3 and the unmanned transport device 2. Therefore, it is possible to efficiently perform the process of stacking a predetermined number of a plurality of types of articles on the pallet by a smaller number of robots (palletizer 3 and the unmanned transport device 2).
(2) The picking system 1 according to a second aspect is the picking system 1 of (1) further including a cargo-type determination unit 200 configured to determine whether or not a type of an article to be stacked on a predetermined finished pallet includes a type of a last article stacked at an end of the finished pallet immediately before the predetermined finished pallet; and a stacking order setting unit 201 configured to set the type of the last article to a type of an article stacked at a beginning of the predetermined finished pallet in a case where it is determined that the type of the article stacked on the predetermined finished pallet includes the type of the last article to be stacked at the end of the immediately before finished pallet.

In the above configuration, in a case where the cargo-type determination unit 200 determines that the type of the last article to be stacked at the end of the immediately before finished pallet is included in the type of the article to be stacked on the predetermined finished pallet, the stacking order setting unit 201 sets the type of the last article to the type of the article to be stacked at the beginning of the predetermined finished pallet. Therefore, the palletizer 3 can stack the same type of articles stacked on the replenishment pallet at the end of a certain finished pallet and then stack the same type of articles at the beginning of the next finished pallet.

That is, it is possible to stack the articles stacked on the same replenishment pallet on two consecutive finished pallets. Accordingly, it is possible to reduce the number of times that the same type of replenishment pallet is supplied (transported) to the palletizer 3 by the unmanned transport device 2. That is, it is possible to reduce the work amount of the unmanned transport device 2. Therefore, it is possible to efficiently perform the process of stacking a predetermined number of a plurality of types of articles on the pallet by a smaller number of unmanned transport devices 2.
(3) The picking system 1 according to a third aspect is the picking system 1 of (1) or (2) further including: a first time comparison and determination unit 300 configured to determine whether or not an estimated time until the same replenishment pallet is used again in a palletizer 3 is equal to or shorter than a predetermined first determination threshold value; and a transport instruction unit 301 configured to transport the replenishment pallet from the palletizer 3 to a temporary placement area 7 by an unmanned transport device 2 in a case where it is determined that the estimated time Is equal to or shorter than the first determination threshold value, and transport the replenishment pallet from the palletizer 3 to a storage area 5 by the unmanned transport device 2 in a case where it is determined that the estimated time is longer than the first determination threshold value.

In the above configuration, in a case where the first time comparison and determination unit 300 determines that the estimated time until the same replenishment pallet is used again in the palletizer 3 is equal to or shorter than the first determination threshold value, the unmanned transport device 2 does not return the replenishment pallet to the storage area 5, and transports the replenishment pallet to the temporary placement area 7 closer to the palletizer 3 than the storage area 5. Accordingly, it is possible to reduce the work amount of the unmanned transport device 2. Therefore, it is possible to efficiently perform the process of stacking a predetermined number of a plurality of types of articles on the pallet by a smaller number of unmanned transport devices 2.
(4) The picking system I according to a fourth aspect is the picking system 1 of (3) in which the first determination threshold value is defined as a value corresponding to a round-trip time during which the unmanned transport device 2 returns the replenishment pallet from the palletizer 3 to the storage area 5 and then transports the replenishment pallet from the storage area 5 to the palletizer 3.

In the above configuration, it is possible to efficiently reduce the work amount of the unmanned transport device 2.
(5) The picking system 1 according to a fifth aspect is the picking system 1 of any one of (1) to (4), further including: a work time estimation unit 302 configured to estimate a work time for the palletizer 3 to pick the article from the same replenishment pallet; a second time comparison and determination unit 303 configured to determine whether or not the estimated work time for the palletizer 3 to pick the article from a predetermined replenishment pallet is equal to or longer than a predetermined second determination threshold value; and a task assignment unit 304 configured to assign the unmanned transport device 2 a task of transporting a next replenishment pallet to the temporary placement area 7 without transporting the next replenishment pallet to the palletizer 3 in a case where it is determined that the estimated work time is equal to or longer than the second determination threshold value, and assign the unmanned transport device 2 a task of transporting the next replenishment pallet to the palletizer 3 in a case where it is determined that the estimated work time is shorter than the second determination threshold value.

In the above configuration, in a case where the second time comparison and determination unit 303 determines that the estimated work time for the palletizer 3 to pick the article from the predetermined replenishment pallet is equal to or longer than the second determination threshold value, the unmanned transport device 2 transports the next replenishment pallet to the temporary placement area 7 without transporting the next replenishment pallet to the palletizer 3. Accordingly, the next replenishment pallet can be left on the temporary placement area 7. Therefore, the task assignment unit 304 can assign another task (for example, a task of transporting an empty pallet or a transport stand) to the unmanned transport device 2. That is, it is possible to reduce the waiting time of the unmanned transport device 2. Therefore, it is possible to efficiently perform the process of stacking a predetermined number of a plurality of types of articles on the pallet by a smaller number of unmanned transport devices 2.

### REFERENCE SIGNS LIST

1 Picking system
2 Unmanned transport device
3 Palletizer
5 Storage area
6 Stacking area
7 Temporary placement area
100 Finished pallet setting unit
101 Article number comparison and determination unit
102 Diversion candidate addition unit
103 Replenishment pallet remaining number confirmation unit
104 Diversion candidate presence/absence determination unit
105 Order assignment unit
200 Cargo-type determination unit
201 Stacking order setting unit
300 First time comparison and determination unit
301 Transport instruction unit
302 Work lime estimation unit
303 Second time comparison and determination unit
304 Task assignment unit
T1 Picking order

1. A picking system comprising:
a finished pallet setting unit configured to set a finished pallet, on which a plurality of types of articles are stacked, based on an input picking order;
an article number comparison and determination unit configured to determine whether or not the number of predetermined type articles in the finished pallet is equal to or greater than a predetermined ratio of the number of the predetermined type articles in a full single SKU pallet on which only the predetermined type articles are stacked;
a diversion candidate addition unit configured to add the finished pallet to a diversion candidate in a case where in a case where it is determined that the number of the predetermined type articles in the finished pallet is equal to or greater than the predetermined ratio of the number of the predetermined type articles in the full single SKU pallet;
a replenishment pallet remaining number confirmation unit configured to check the number of remaining articles in a replenishment pallet after picking a predetermined number of articles according to the picking order;
a diversion candidate presence/absence determination unit configured to determine whether or not the finished pallet having the number of the predetermined type articles matching the number of remaining predetermined type articles in the replenishment pallet is present in the finished pallet of the diversion candidate; and
an order assignment unit configured to assign an order of the finished pallet of the diversion candidate to immediately after another finished pallet configured by picking the predetermined number of articles from the replenishment pallet having the predetermined type articles according to the picking order in a case where it is determined that the finished pallet, in which the number of the remaining predetermined type articles in the replenishment pallet matches the number of the predetermined type articles in the finished pallet, is present in the diversion candidate of the finished pallet.

2. The picking system according to claim 1, further comprising:
a cargo-type determination unit configured to determine whether or not a type of an article to be stacked on a predetermined finished pallet includes a type of a last article to be stacked at an end of the finished pallet immediately before the predetermined finished pallet; and
a stacking order setting unit configured to set the type of the last article to a type of an article stacked at a beginning of the predetermined finished pallet in a case where it is determined that the type of the article stacked on the predetermined finished pallet includes the type of the last article to be stacked at the end of the immediately before finished pallet.

3. The picking system according to claim 1, further comprising:
a first time comparison and determination unit configured to determine whether or not an estimated time until the same replenishment pallet is used again in a palletizer is equal to or shorter than a predetermined first determination threshold value; and
a transport instruction unit configured to transport the replenishment pallet from the palletizer to a temporary placement area by an unmanned transport device in a case where it is determined that the estimated time is equal to or shorter than the first determination threshold value, and transport the replenishment pallet from the palletizer to a storage area by the unmanned transport device in a case where it is determined that the estimated time is longer than the first determination threshold value.

4. The picking system according to claim 3, wherein
the first determination threshold value is defined as a value corresponding to a round trip time during which the unmanned transport device returns the replenishment pallet from the palletizer to the storage area and then transports the replenishment pallet from the storage area to the palletizer.

5. The picking system according to claim 1, further comprising:
a work time estimation unit configured to estimate a work time for a palletizer to pick the article from the same replenishment pallet;
a second time comparison and determination unit configured to determine whether or not the estimated work time for the palletizer to pick the article from a predetermined replenishment pallet is equal to or longer than a predetermined second determination threshold value; and
a task assignment unit configured to assign an unmanned transport device a task of transporting a next replenishment pallet to a temporary placement area without transporting the next replenishment pallet to the palletizer in a case where it is determined that the estimated work time is equal to or longer than the second determination threshold value, and assign the unmanned transport device a task of transporting the next replenishment pallet to the palletizer in a case where it is determined that the estimated work time is shorter than the second determination threshold value.
